(19) United States
(12) Patent Application Publication
(10) Pub. No.: US 2011/0213678 A1
(43) Pub. Date: Sep. 1, 2011

(54) COMPUTERIZED SYSTEM FOR E-COMMERCE SHOPPING IN A SHOPPING MALL

(76) Inventor: Robert Conlin Chorney, Toronto (CA)

(21) Appl. No.: 13/035,988

(22) Filed: Feb. 27, 2011

Related U.S. Application Data
(60) Provisional application No. 61/308,922, filed on Feb. 27, 2010.

(51) Int. Cl. G06Q 30/00

(52) U.S. Cl. 705/26.61; 705/26.1

(57) ABSTRACT

The present invention is a computerized e-commerce shopping system utilized in a shopping mall that includes a server system having access to a communications network, a memory system with an operating system that obtains, processes and stores e-commerce shopping information, a client system to receive e-commerce shopping information from the server system, a shopping mall website and a plurality of password protected micro shopping sites with a combined product database distributed to every retailer in the shopping mall to integrate seamlessly into the shopping mall websites.

This application claims priority to U.S. Provisional Application 61/308,922 filed on Feb. 27, 2009, the entire disclosure of which is incorporated by reference.

### TECHNICAL FIELD and BACKGROUND

Although Internet sales are the fastest growing profit sector in consumer retailing, in the case of shopping malls, where a store's online sales are often excluded from their percentage lease agreements, they account for millions of dollars in lost income. And although man shopping malls spare no expense in developing state of the art websites, since they themselves are not vendors, their websites are unable to feature online shopping, ostensibly cutting them off from the online marketplace entirely.

This problem is best exemplified by large shopping mall owners, developers and managers. Upon even minimal investigation, an all important feature absent on the websites of their shopping malls throughout Canada happens to be online shopping. To the consternation of both the consumer and the retailers alike, this is particularly notable because many of their malls spare no expense in producing otherwise attractive, state of the art websites. Purchasing items through the Internet is an alternate mode of shopping for millions of their customers and online sales continue to be the fastest growing revenue sector in all of retail sales with U.S. estimates for 2011 being 171.1 billion. Furthermore, not only is online shopping not available on any of their shopping mall websites, they will provide neither a link nor even the URL to the websites of those stores within their malls which not only provide and promote online shopping, in some cases upwards of 50% of the stores, but in many cases rely on online shopping as a significant percentage of their annual sales.

Although it seems exceedingly contradictory that shopping malls should be virtually shut out from the online sales, this exists for a reason. It exists because the lease agreements entered into by the malls and many of their stores contain a formula which entitles them to a percentage of the store's sales. However, in the case of a store's online sales which are not the physical result of consumer traffic within the actual mall itself that same percentage becomes more difficult to justify and is often entirely circumvented. And since the malls themselves are not vendors and have no products of their own to sell online, not only do they not derive a benefit from online sales, they would rather discourage it altogether as it actually results in a loss of income relative to the customer who buys in person, thereby increasing the store's sales, of which they can then derive their percentage.

The present invention generally relates to a computerized system. More specifically, the invention is a computerized system for e-commerce shopping in a shopping mall.

It is an object of the invention to provide a computerized system for e-commerce shopping that enables actual shopping malls that includes shopping centers to provide a convenient, one stop online shopping experience for the consumer directly from the mall's own website.

It is an object of the invention to provide a computerized system for e-commerce shopping that addresses a retailer's frustration at not being able to sell to those consumers and a mall's frustration at not being able to derive a viable revenue stream from those customers.

It is an object of the invention to provide a computerized system for e-commerce shopping that provides an individual retailer within a mall an additional and highly visible sales channel from which to generate additional revenues, while at the same time allowing the mall itself to include such revenues in their percentage lease formula just as they might otherwise do with conventional sales revenue.

It is an object of the invention to provide a computerized system for e-commerce shopping that provides a store to create and market their own self administrated micro-shopping site from directly within the actual mall website while the store enjoys the addition of a new revenue stream, with the shopping mall afforded a fully integrated online shopping platform to a master product database, a mall wide search engine, a universal shopping cart and a unified wish list and gift registry from which to feature a fully integrated one stop online shopping experience while generating and participating in mall wide online sales revenues.

What is really needed is a computerized system for e-commerce shopping that enables actual shopping malls that includes shopping centers to provide a convenient, one stop online shopping experience for the consumer directly from the mall's own website, that addresses a retailer's frustration at not being able to sell to those consumers and a mall's frustration at not being able to derive a viable revenue stream from those customers, that addresses a retailer's frustration at not being able to sell to those consumers and a mall's frustration at not being able to derive a viable revenue stream from those customers, that provides an individual retailer within a mall an additional and highly visible sales channel from which to generate additional revenues, while at the same time allowing the mall itself to include such revenues in their percentage lease formula just as they might otherwise do with conventional sales revenue and that provides a store to create and market theft own self administrated micro-shopping site from directly within the actual mall website while the store enjoys the addition of a new revenue stream, with the shopping mall afforded a fully integrated online shopping platform to a master product database, a mall wide search engine, a universal shopping cart and a unified wish list and gift registry from which to feature a fully integrated one stop online shopping experience while generating and participating in mall wide online sales revenues.

### SUMMARY OF THE INVENTION

One embodiment of the invention is to provide a unique opportunity for a shopping mall to offer online shopping within their website.

Another embodiment of the invention provides a unique opportunity for a shopping mall to promote sales and derive a revenue stream from each store's online sales.

Another embodiment of the invention provides a unique opportunity for a shopping mall to initiate an unlimited array of online sales, marketing, promotional and special event campaigns and initiatives, provide one stop, mall-wide online product searches, wish lists, custom catalogs and gift registries.

Another embodiment of the invention provides a unique opportunity for a shopping mall to amalgamate multiple customer deliveries for items purchased from multiple stores by the same person, thereby addressing significant environmental and transportation considerations.

Another embodiment of the invention provides a unique opportunity for a shopping mall and its stores to generate one or more IPhone shopping applications.

Another embodiment of the invention provides a unique opportunity for a shopping mall to provide mall-wide comparative shopping directly juxtaposing like products from different stores and malls, all within the same site, search query and purchasing protocol.

Another embodiment of the invention provides a unique opportunity for a retailer to increase the number of online sales and marketing cross-channels through one online application.

Another embodiment of the invention provides a unique opportunity for a retailer to offer a live online on-camera sales and information desk.

Another embodiment of the invention provides a unique opportunity for a retailer to access, view products and purchase from an exponential network of online suppliers and a reciprocal opportunity for suppliers to market their products to an exponential network of online retailers.

Another embodiment of the invention provides a unique opportunity for a consumer to shop online at any store, or combination of stores, in any mall, or combination of malls, within any city, country or region of the world, or a combination therein, using one website, search engine, shopping cart, custom catalogue, gift registry and wish list.

Another embodiment of the invention provides a unique opportunity for a consumer to view a greater number of product images, product categories and product sub-categories online with a minimum of vertical scrolling.

Any of the above embodiments may be used alone or together with one another in any combination and may also include embodiments that are only partially mentioned or alluded to or are not mentioned or alluded to at all in this brief summary or in the abstract.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the system architecture of the computerized system for e-commerce shopping, in accordance with one embodiment of the present invention.

FIG. 2 illustrates a block diagram of the server system of the computerized system for e-commerce shopping, in accordance with one embodiment of the present invention.

FIG. 3 illustrates a block diagram of the client system of the computerized system for e-commerce shopping, in accordance with one embodiment of the present invention.

FIG. 4A illustrates a first shopping mall webpage of the computerized system for e-commerce shopping, in accordance with one embodiment of the present invention.

FIG. 4B illustrates a second shopping mall webpage of the computerized system for e-commerce shopping, in accordance with one embodiment of the present invention.

FIG. 4C illustrates a third shopping mall webpage of the computerized system for e-commerce shopping, in accordance with one embodiment of the present invention.

FIG. 4D illustrates a fourth shopping mall webpage of the computerized system for e-commerce shopping, in accordance with one embodiment of the present invention.

FIG. 4E illustrates a fifth shopping mall webpage of the computerized system for e-commerce shopping, in accordance with one embodiment of the present invention.

FIG. 4F illustrates a micro shopping site webpage of the computerized system for e-commerce shopping, in accordance with one embodiment of the present invention.

FIG. 4G illustrates a main feature bar webpage of the computerized system for e-commerce shopping, in accordance with one embodiment of the present invention.

FIG. 4H illustrates a multiple mall webpage of the computerized system for e-commerce shopping, in accordance with one embodiment of the present invention.

FIG. 4I illustrates a shopping cart webpage with a universal shopping cart of the computerized system for e-commerce shopping, in accordance with one embodiment of the present invention.

FIG. 4J illustrates a live online on camera sales and information desk webpage of the computerized system for e-commerce shopping, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

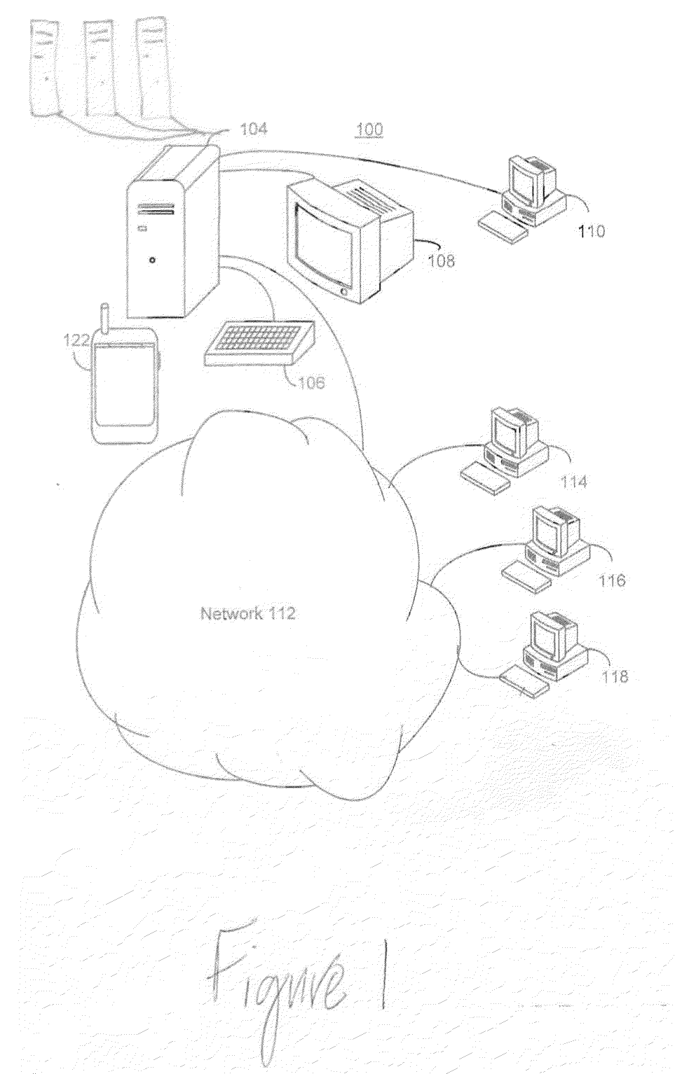

FIG. 1 illustrates an overview of the system architecture of the computerized system for e-commerce shopping 100, in accordance with one embodiment of the present invention. The computerized system 100 includes a server system 104, an input system 106, an output system 108, a plurality of client systems 110, 114, 116 and 118, a communications network 112 and a hand-held device 122. In other embodiments, the computerized system 100 may include additional components and/or may not include all of the components listed above. The server system 104 may have one or more servers. One server 104 may be the property of the distributor of the software application and then each individual mall or store may have their own server also. In other embodiments, the computerized system 100 may include additional components and/or may not include all of the components listed above.

There is also an input system 106 system that may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

There is also an output system 108 which may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

The server system 104 may be directly connected and/or wirelessly connected to the plurality of client systems 110, 114, 116 and 118 are connected via the communications network 112. The communications network 112 may be any one of, or any combination of, one or more Local Area Networks (LANs), Wide Area Networks (WANs), wireless networks, telephone networks, the Internet and/or other networks. The communications network 112 may include one or more wireless portals. The client systems 110, 114, 116 and 118 are any system that an end user may use to access the server system 104. For example, the client systems 110, 114, 116 and 118 may be personal computers, workstations, laptop computers, game consoles, handheld network enabled audio/video players and/or any other network appliance.

The client system 122 is an example of a handheld wireless device, such as a mobile phone or a handheld network enabled audio/music player, which may also be used for accessing network content. The client system 122 can also be utilized in combination with a handheld wireless device application such as an IPhone application that contains the application for e-commerce shopping.

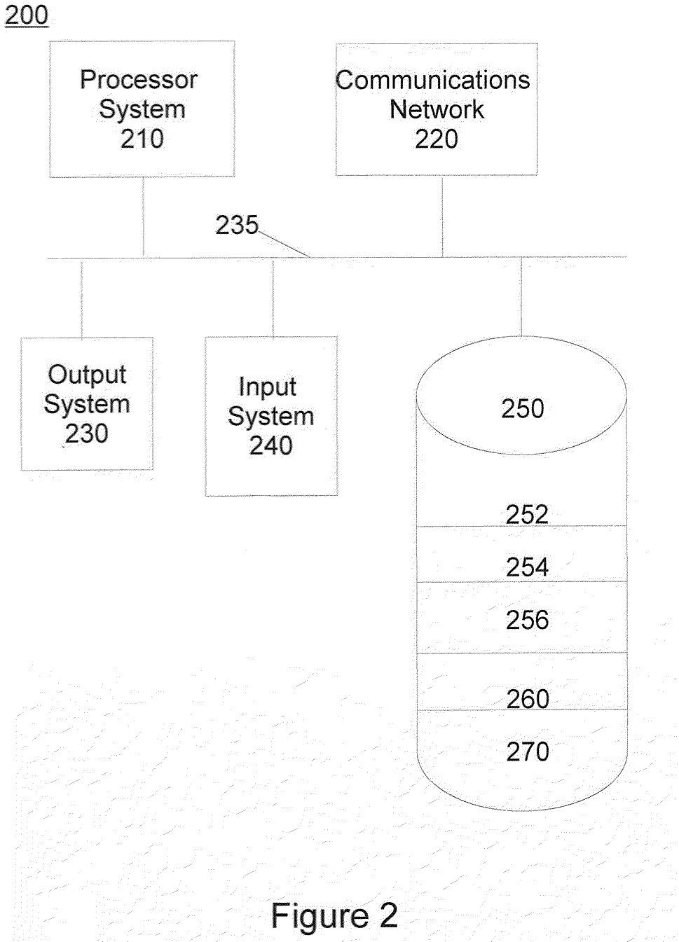

FIG. 2 illustrates a block diagram of the server system 200 of the computerized system for e-commerce shopping, in accordance with one embodiment of the present invention. FIG. 2 illustrates a block diagram of the server system 200 of the portable networked digital video surveillance system, in accordance with one embodiment of the present invention. The computerized portable digital video surveillance system 100 also includes a server system 200 with a processor system 210, a communications interface 220, an input system 230, a communications system 235 and an output system 240 having access to a communications network 220.

The processor system 210 may include any one of, some of, any combination of, or all of multiple parallel processors, a single processor, a system of processors having one or more central processors and/or one or more specialized processors dedicated to specific tasks. The processor system 210 implements the programs stored in the memory system 250.

The communications network 220 may be any one of, or any combination of, one or more Local Area Networks (LANs), Wide Area Networks (WANs), wireless networks, telephone networks, the Internet and/or other networks. The communications network 220 allows outside users to gain access to the server system 140 typically through another client system (not shown).

The output system 230 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

The communications system 235 communicatively links the processor system 210, the output system 230, the input system 240 and the memory system 250. The communications system 212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

The input system 240 may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

The server system 200 also includes a memory system 250 with an operating system 252, a communications module 254, a web browser module 256, an e-commerce shopping application 260 that obtains, processes and collects e-commerce shopping information and a combined product database 270. The memory system 250 may include, for example, any one of, some of, any combination of or all of a long term storage system, such as a hard drive, a short term storage system, such as random access memory, a removable storage system, such as a floppy drive or a removable drive, and/or a flash memory. The memory system 250 may include one or more machine readable mediums that may store a variety of different types of information. The term machine-readable medium is used to refer to any medium that is structurally configured for carrying information in a format that is readable by a machine. One example of a machine-readable medium is a computer-readable medium.

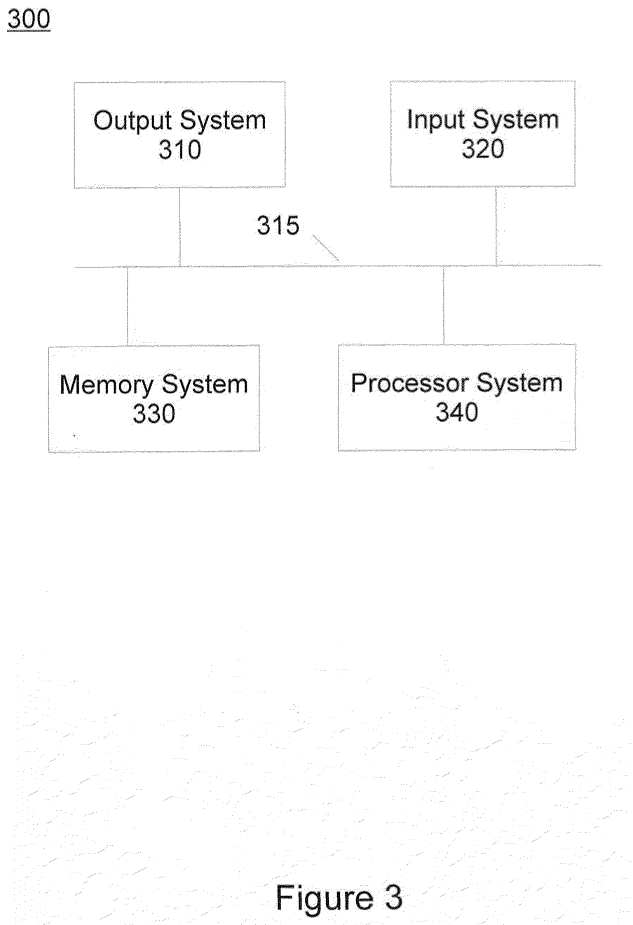

FIG. 3 illustrates a block diagram of the client system 300 of the computerized system for e-commerce shopping, in accordance with one embodiment of the present invention. The client system 300 includes an output system 310, a communications system 315, an input system 320 and a memory system 330 and a processor system 340. The client system 300 is in communication with the server system 200 to receive e-commerce information from the server system 200. The specific types of output systems 310, communications systems 315, input systems 320 and processor systems 340 are the same as described in the FIG. 2 description.

With the web based application software or stand alone software, the client Shopping Mall is given a password to the Mall Management Feature of the invention (the software). This enables the Mall to designate individual Micro Shopping Sites for each of their Retailers. The Shopping Mall then e-mails a password to each Retailer which in-turn gives the Retailers access to the Store Management Feature of the invention whereupon they upload their products (images, descriptions, prices etc) thus creating their own Micro Shopping Sites.

Once each store has set-up their respective Micro Shopping Sites, the Shopping Mall then places a “link” on their current Website entitled “Shop Online” which, when clicked, calls up our software application, customized to replicate the look and feel of the client website. Our home page presents the user with a main feature bar consisting of a favorite Search Log, a Custom Catalogue Feature (mall-wide), a Public Wish List Feature (mall-wide), a Public Gift Registry (mall-wide), and a member “sign in”. Below the main feature bar are Product Search options by Category or by Keyword (which queries the combined product databases of all stores simultaneously), as well as a pull-down menu listing all the stores in the mall. The user can either shop the entire mall simultaneously, or shop individual stores by clicking on the store's name in the pull down menu. In the case of the latter, the selected store's micro shopping site comes up, also integrated seamlessly into the site. In this case, the main feature bar remains the same (i.e., remain unified Mall-Wide features), while the product search capability reverts exclusively to the selected store. In either case, actual product sales are processed by the individual store's Micro-Site thus ensuring that the mall is removed from actual sales transactions. In short, all Micro-Shopping Sites are no different than conventional state of the art e-commerce stores, with the exception of facilitating a shared database.

The invention enables actual shopping malls (including shopping centers) to provide a convenient, “one stop online shopping experience” for the consumer directly from the mall's own website. This provides the individual retailer (within the mall) an additional and highly visible “sales channel” from which to generate additional revenues, while at the same time allowing the mall itself to include such revenues in their percentage lease formula just as they might otherwise do with conventional sales revenue. In practice, the invention allows each store to create and market their own self administrated “Micro Shopping Site” from directly within the actual mall website. Hence, while the store enjoys the addition of a new revenue stream, the shopping mall is afforded a fully integrated “online shopping platform” (a master product database, a mall-wide search engine, a universal shopping cart and a unified wish list and gift registry) from which to feature a fully integrated “one stop online shopping” experience while generating and participating in mall-wide “online sales revenues”. Furthermore, the invention facilitates: 1) Multi-Mall administrative scalability, thus allowing property developers to generate and manage online sales for numerous malls at one time, 2) Shopper Customized “Super Malls” which provide retailers with a sales channel by amalgamating each mall's online sales feature into a separately configured and marketed website (i.e., shoprealmalls.com), which enables an online shopper to customized a “one site” shopping experience based not only on a “single mall” but on any number of malls selected locally, regionally, nationally or internationally etc., then combined into a world-wide (customized) “super mall”, providing universal search, wish list/gift registry and shopping cart convenience along with an unprecedented “comparative shopping” capability.

Each online store features web page authoring tools, standardized style templates, set up wizards, creates forms, imports data files (from their existing websites), supports unlimited product categories, filters product searches, creates navigation controls, adds additional pages to site, supports individual product promotion, supports site promotion, updates site automatically, supports banner advertising, supports multiple pricing levels, reviews and duplicates previous orders, supports multiple colors, sizes etc., manages graphics, facilitates advanced product searches, includes privacy policy page, true thumbnail handling, sizes and manipulates product images, sets store to be offline, has logout option from the store, fine tuned control of display order of products, multiple hostnames for the stores, Universal shopping cart, calculates tax, calculates shipping, handles non-US taxes and shipping, performs credit card validation, can accept credit card/check or money order, can accept Internet check, retains session information, does inventory tracking, offers SSL or other security, provides customer e-mail confirmation, provides merchant e-mail notification, can review orders online, can search and filter orders, has regular postal service options, UPS/Fed-Ex shipping option, allows free products, has Max/Min Order quantities per product, does discount percentage per customer, has discount table quantity or percentage, handles backorders and multiple shipments, UPS/Fed-Ex tracking ability, facilitates use of shipping zone tables, has pickup shipping option, does refund processing from the admin panel, is 30+0 payment processors supported, has wizards and help system, offers secure administration module, can create sales reports, can create site reports, can export data files, facilitates banner sales and management, facilitates favorite searches, supports mailing lists, customer management, user documentation, Java Script help in admin system, inventory handling, multiple users levels for the admin, separate error e-mail address, fast style data entry system, price change utility, edits subject content for all system e-mails, disallow discounts on certain products, sets certain products only available to members, Import/Export inventory data, able to mass delete orders, provides low stock level notifications, provides sales reports by category, allows date range selections on any report, provides gift registry, provides custom catalog, provides public wish lists, supports gift certificates, provides contact information, mall specific features, master shopping basket (single checkout), custom billing plans for stores, ability to change feature sets of stores, ability to turn off a store, end user interface to create stores, overall search engine across stores, multi-filtered search engine, ability for user to set number of lines per page, automated monthly billing and accounting features, automated e-mail features, facilitates One-Stop shopping from individual stores, multiple stores or mall-wide, provides Universal gift Registry, provides Universal Custom Catalog, provides Universal Public Wish Lists, supports gift certificates and provides contact information.

The site is a multi-layered e-commerce environment which allows physical malls to initiate and benefit from e-commerce transactions. Malls are provided with the online facilities to create and manage themselves alternatively and concurrently as “virtual malls”, which host e-commerce shops (Micro Shopping Sites) corresponding to each of the shops available on location. Users can browse the “virtual mall” in a number of ways, searching all stores for specific products or browsing products in a specific store. Users can also view all stores carrying a given product, with prices and the ability to select the store their item will be ordered from. Upon completion of an order, customer billing and order information is dispatched to each store individually for payment processing and shipment. These sales are tracked in relation to the user's point of entry on the site, and some percentage of these sales may be paid back to the Mall and/or the site itself.

The application is implemented in the iHTML server side scripting language developed by Inline Internet Systems, Inc., while the data store is a PostgreSQL database. The front end of the site incorporates HTML/CSS, images and Java Script. The administrative panels for all account types use typical HTML web forms and HTTP POST/GET methods. Java script and “AJAX” functionality is also employed to enhance the users experience. Session and authentication information is managed via HTTP cookies, which are set upon the user's first page load, even if the user has not authenticated. From a technical design perspective the prototype site uses a relational SQL database, with many postgres functions (AKA stored procedures) used to furnish the Java script/HTML front end with appropriate data. Database and web server communication is facilitated by the iHTML language. The implementation expands on a traditional e-commerce model. The traditional model in this case being individual retailers (shops) provided with administrative panels allowing them to manipulate customer and product related database contents through the “back-end” of the site, while shopping customers are presented with the customer related data via the front-end of the website. Both shoppers and retailers are working with the same data store, but in different capacities. There are two further layers of management that are included in the site, with the structure appearing as follows:

Root Administrator (overall site administrator):

|- - - [Administrative reports and accounts backend]
   |
   |_Mall Admin/Manager (per-single mall and per multi-malls)
   |
   |- - - [Mall Admin backend, CMS, reports, Store management.]
   |
   |_Stores (one per store)
   |
   |- - - [stores e-commerce backend.]

Shoppers browse within this hierarchy, and are presented with information from the data store which is tailored specifically to their point of entry on the site. The point of entry tracking and the related representations of the site are critical to the core functionality. The underlying scripts process a user's point of entry and include or exclude specific data from the user's shopping experience. This includes not only the stores and browsing options available to the user, but also the overall appearance of the site, which is customized per mall, as well as Mall managed content (CMS) pages.

The administrative facility for malls allows the mall to submit a banner image of specified dimensions, as well as select a color scheme. The site uses the logo image and color scheme information to dynamically generate appropriate layout images, box borders, buttons, decorations etc. to create a branded site which corresponds with the physical mall's actual branding strategy. When a user's point of entry correlates to a given mall, the dynamic image generation functionality alleviates the need for custom design work, it is achieved via iHTML's built-in image generation functions, which utilize the GD library. Selection of an image and color scheme is facilitated through an HTML form with a content type of “multipart/form-data”, submitted via an HTTP POST request. The receiving iHTML script stores the image on the server file system and stores the color selections in the data store. Although individual stores may also download a set of existing template files to modify and create stand alone websites with separate URLs, in this application each retailer uses a standard template with a set of files which correspond to specific displays within the store, such as product listings and individual product views. Stored in the database, iHTML retrieves that information and accesses the related files at display time.

Each mall in the system resides in a database table which is relative to a city, while cities are in turn relative to an overall world-wide geography. This structure allows users to navigate the site and view a list of stores by mall, malls by City, Country, Region and/or Continent. If a user's point of entry (determined by accessing URL) correlates to a specific mall, the site is rendered using the selected Mall's logo and colors, which are managed as previously discussed and the user's shopping experience is then limited to the shops present in that mall. Any items added to the user's shopping cart are stored in the database, using a unique ID generated and stored in a local cookie. When users have completed their shopping and proceed to the “check out” page, they are presented with a series of html forms, either logging in and completing payment/shipping details, or registering a new account and completing payment/shipping details. In both cases HTML forms are submitted via HTTP POST requests, which are processed via iHTML scripts, validating the data before storing the information in the data store and forwarding the user to the next stage of the checkout procedure. The application then retrieves the cart contents and their related retailers, iterating over each item and dispatching the payment and shipping details to the individual retailers via standard e-mail messages.

Beyond the typical purchasing process described, the application continues to refer to the user's point of entry. If the point of entry is a specific mall and the purchases are made within the related “virtual mall”, the site tracks and stores the details of the sale. Administrative and Mall users can then view reports on this data drawn from the database. If a user's point of entry is the base URL of the site, the application behaves very differently, presenting the user with a new feature set which facilitates browsing searching and selecting products, stores, and malls from all available options in the database. Initially the user is assumed to be “shopping the world”. Facilities are provided to browse products by category, as well as a search form with a text field which submits an HTTP GET request is provided, submission returns, matching regions, malls or stores.

There is a separate search function for matching product names. In both cases the form submits to an iHTML script which handles database searching and rendering results. Users can select specific stores, malls, cities or regions etc. they wish to shop within based on search results, or by browsing lists broken down by individual stores, individual malls, cities, countries, regions and continents. The system stores the user's selections within the cookie, and retrieves only database records which are relevant to the user's selections. Any combination of individual stores, malls, malls within specified cities, regions, countries or continents may be selected and searched, following the same workflow as the previously mentioned mall-specific shopping. The shopper may add items from various stores into their cart, and upon checkout these are retrieved, processed, and the appropriate information is dispatched to the individual retailers for processing. The user's region/city/mall/store selections persist until they are purposely reset by the user, which clears the cookie.

In addition to persistent International, Regional, National, Municipal and Individual Mall and/or Store selection, the user can also bookmark (favorite) searches for future retrieval. All of the user's session data is stored in the database and thus maintained in a bookmarked search. Upon calling a bookmarked search, the iHTML scripts process retrieve the session details and re-establish the bookmarked state, allowing the user to instantly return to a previously selected state to resume or repeat their previous shopping experience.

When a shopper is browsing products by categories (departments), they can preview subcategories of a given department by positioning their mouse over a categories title prior to clicking on that title. Upon positioning there, an HTML div is rendered via java script, which makes an AJAX call to an iHTML script, passing it the category ID and receiving a list of populated subcategories in return.

When a user is viewing a “thumbnail” of a particular item, they can “drill down” on that specific product by clicking its title. This takes the user to an iHTML page which queries the database for all products sharing the same UPC within the user's search limitations. A list of all stores carrying this product is then displayed to the user, with the associated prices. The user can then switch which store they are ordering the given product from. This change is submitted to an iHTML script which adjusts the user's shopping cart as appropriate. The above functions allow the end-user to have an unprecedented and unparalleled comparison shopping capability. The software also facilitates the unique ability to view a greater number of product images, product categories and product sub-categories with a minimum of vertical scrolling.

This function allows the user to store a given cart (set of products) in the database, for retrieval later. On return visits the user can select a given custom catalog, and an iHTML script will populate the user's current shopping cart with the custom catalog option. Upon purchasing, the selected products and stores are retrieved, processed and dispatched to the retailers in the same way as a regular shopping cart item.

The wish list and gift registry allows a user to select products from any store in any mall anywhere in the world, and publishes them in a central data bank. So rather than having to register with each individual store that carries the products you want, and advise family and friends accordingly, the software has the user register only once, whereby the selections are automatically entered into a central data bank and ostensibly creating a world-wide wish list and gift registry interface. Combining malls aside from enabling a multi-mall owner to feature on-line shopping on the websites of each of their shopping malls, the invention also allows them to combine their malls into one “online Super Mall”.

The invention includes a marketing component which enables a mall to launch their website's “online shopping feature” with an “online midnight madness sale”. This is facilitated by a toggle switch: 1) on the mall's admin panel, allowing the “mall” to alternate from its regular banner to a Midnight Madness banner, and 2) on the store admin panels, allowing “stores” to alternate from their regular pricing to (pre-set) Midnight Madness prices automatically. A supply-side website (sister site) is created by essentially inverting and re-targeting the user interface whereby the retailers become the “End Users” (consumers), while “wholesalers” (product suppliers) occupy the stores. In this case, the point of entry for the retailer is from an automatic Inventory Management feature which allows for product re-ordering.

The root administrator and malls are given a utility to transmit notices to Malls or Stores below them in the hierarchy (shown above). A notice is typed by the sender and stored in the database and is then retrieved and displayed to recipients at login time. The total number of products and categories available to be used by individual retailers is stored in the database and can be adjusted by the mall manager or root administrator. This information is stored in a table, and retrieved by iHTML for enforcement when the retailer logs in to the administrative areas.

Administrators and mall managers can also adjust per-store values relating to royalties owing. Much like the limits pertaining to the total number of products and categories, this information is stored in a database table, which is retrieved and used by iHTML when generating sales reports for the root and mall users. Billing to the various stores can be disabled entirely (free access for the given store), set to a specified percentage of sales, set to a specified flat rate per time period (monthly, annually etc.), or any combination of the above. Most calculations are managed through functions stored in postgre SQL, which are called by iHTML. I Phone applications for the invention would allow stores unprecedented access to a worldwide mobile market.

The invention can be used by stores to create stand alone E-commerce shopping sites, facilitating individual and/or cross channel sales and marketing outlets, complete with an exclusive URL. The invention can be used by shopping malls to facilitate mall-wide online shopping, which in-turn provides them with a revenue stream based on a retailer's online sales. The invention can be used by multi-mall owners to facilitate one stop multi-mall online shopping, providing them with a revenue stream based on a retailer's online sales. The invention can be used as a standalone one stop multi-mall shopping website. The invention can be used as a public wish list and gift registry which unifies the wish list and gift registry features of an exponential number of individual stores thereby providing the consumer with unprecedented one stop access.

The invention can be used by both retailers and suppliers providing each with an exponential database of prospective products and clients within a single online network from the automated product re-order feature contained in the inventory section of the store management program, which notifies the product suppliers when inventories are low.

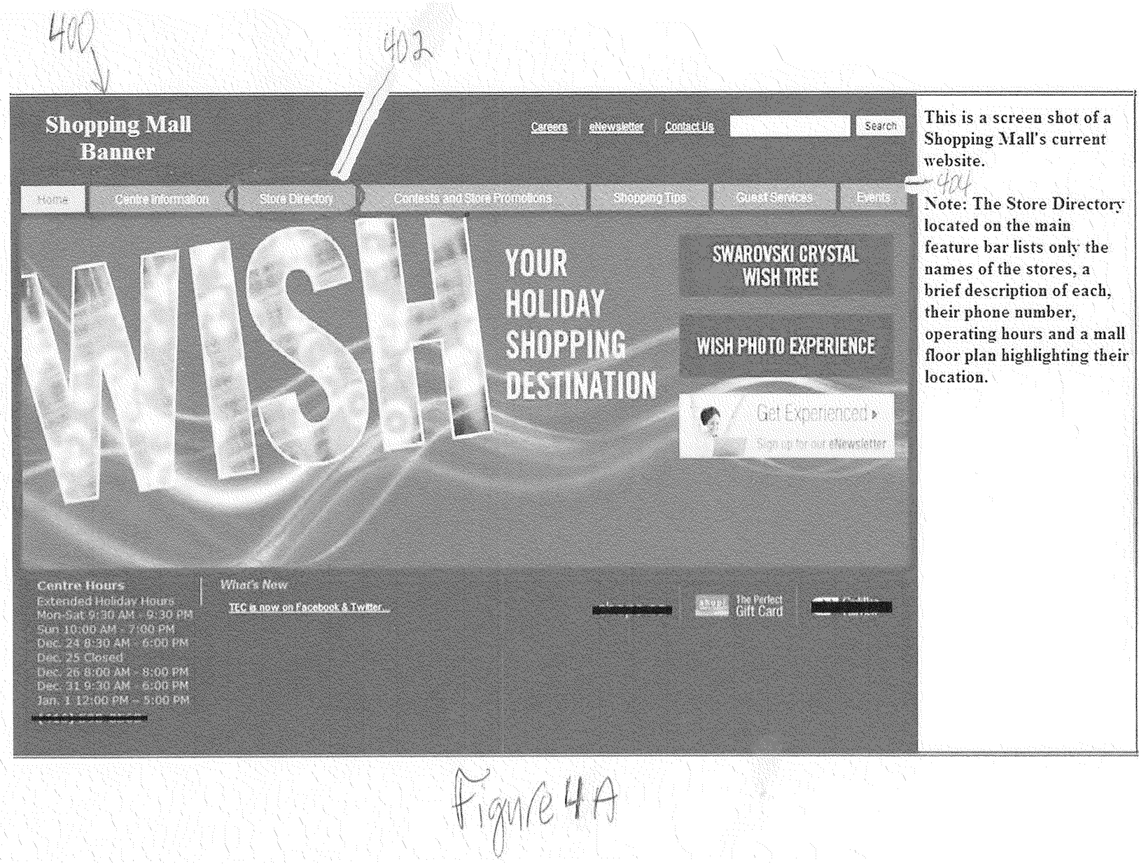

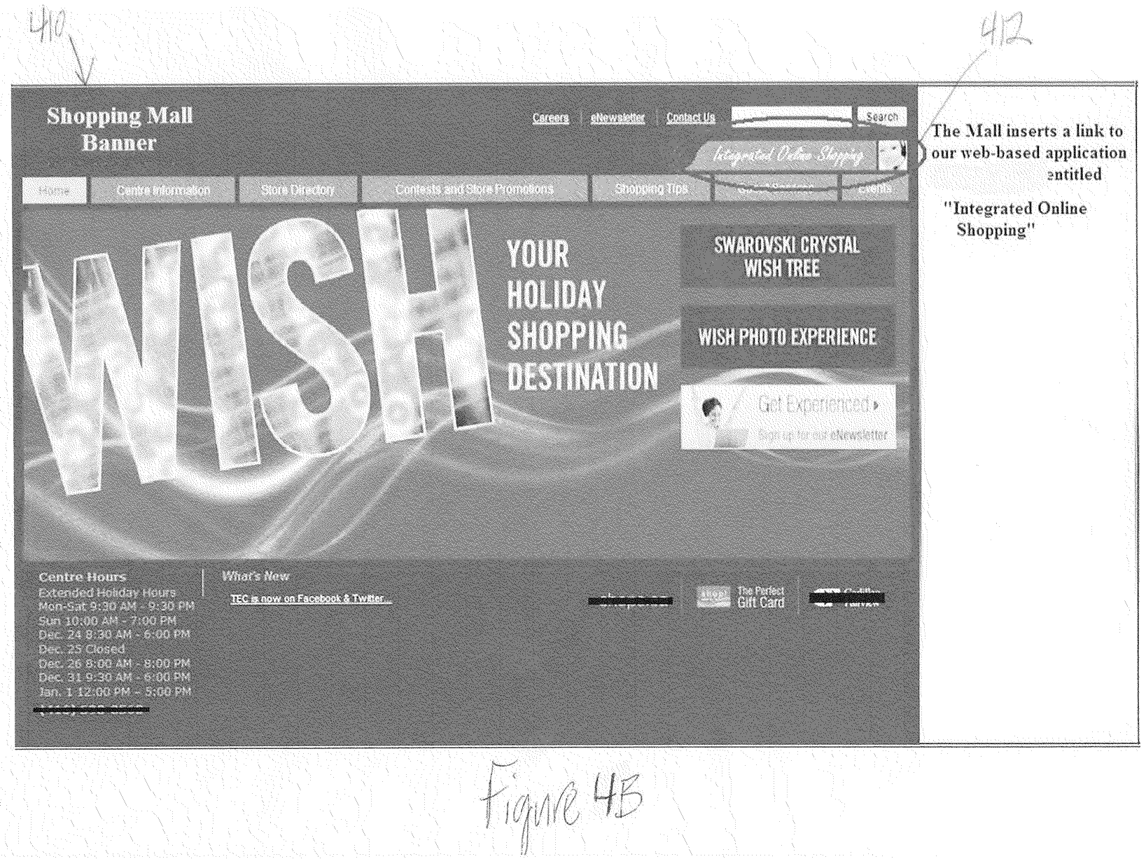

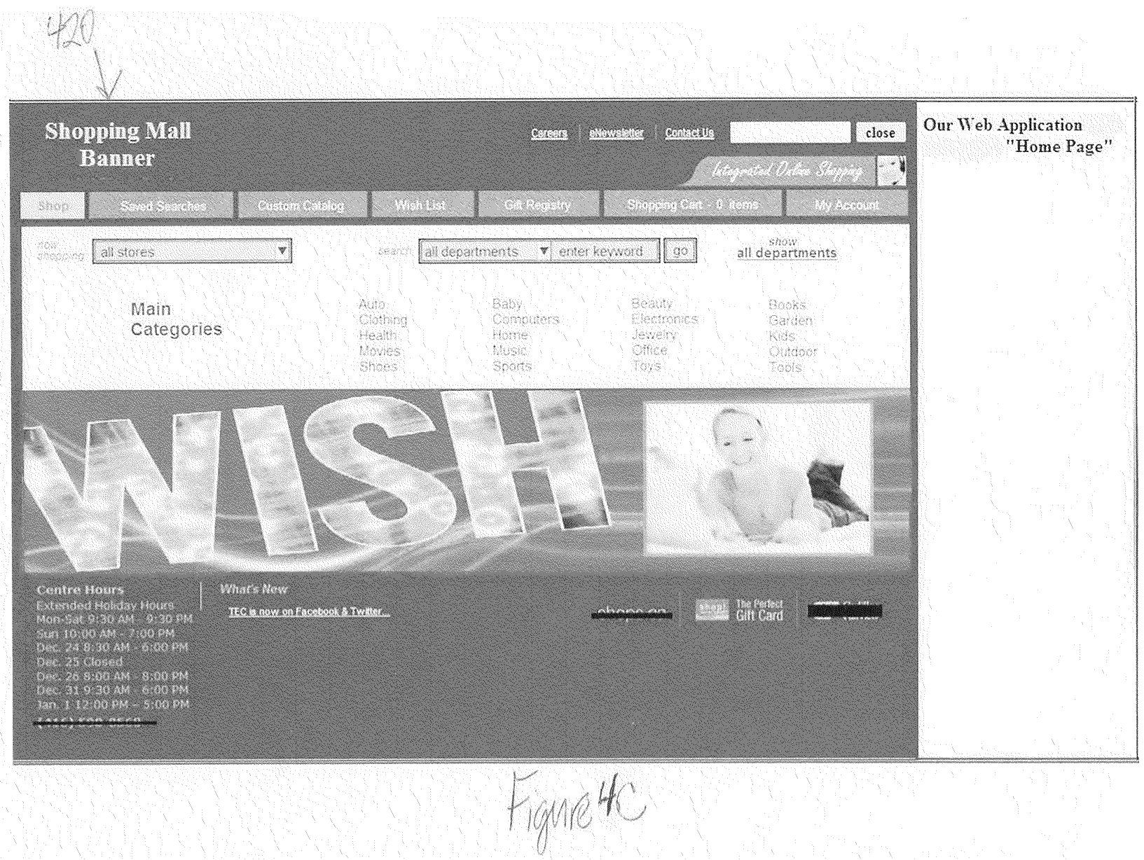

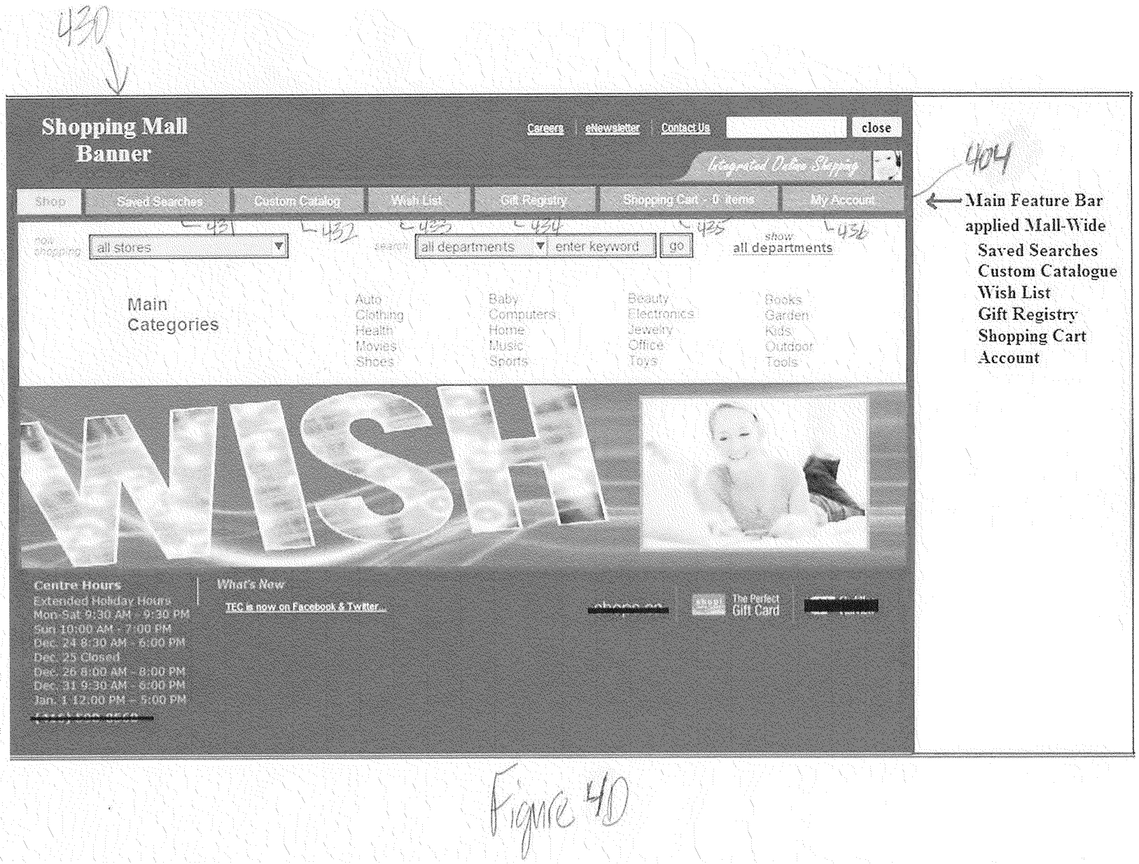

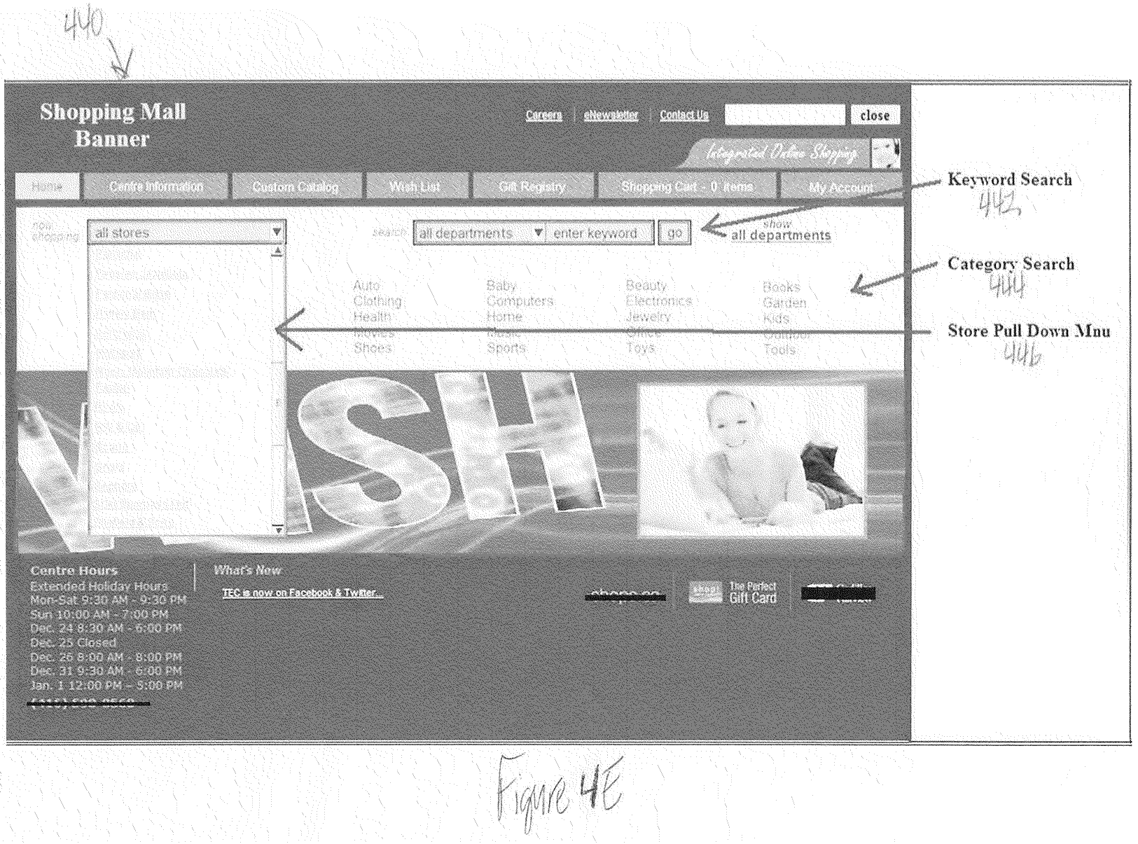

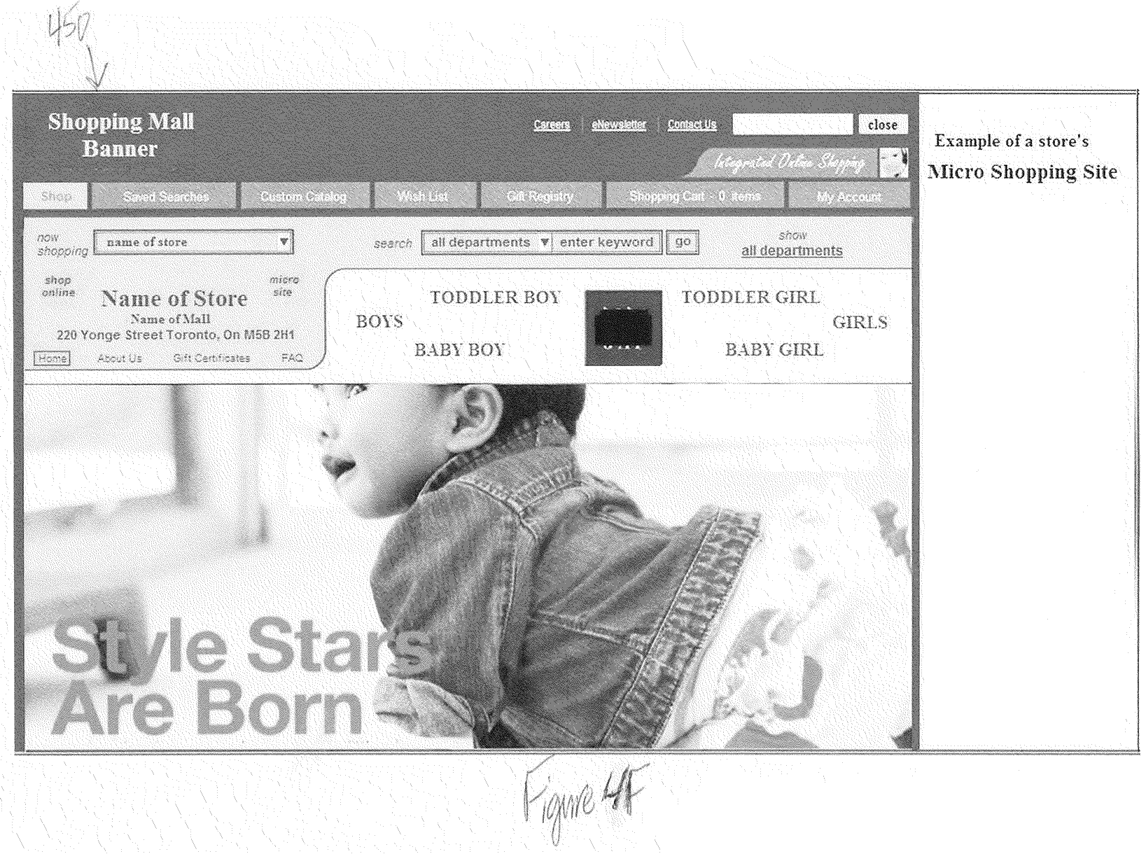

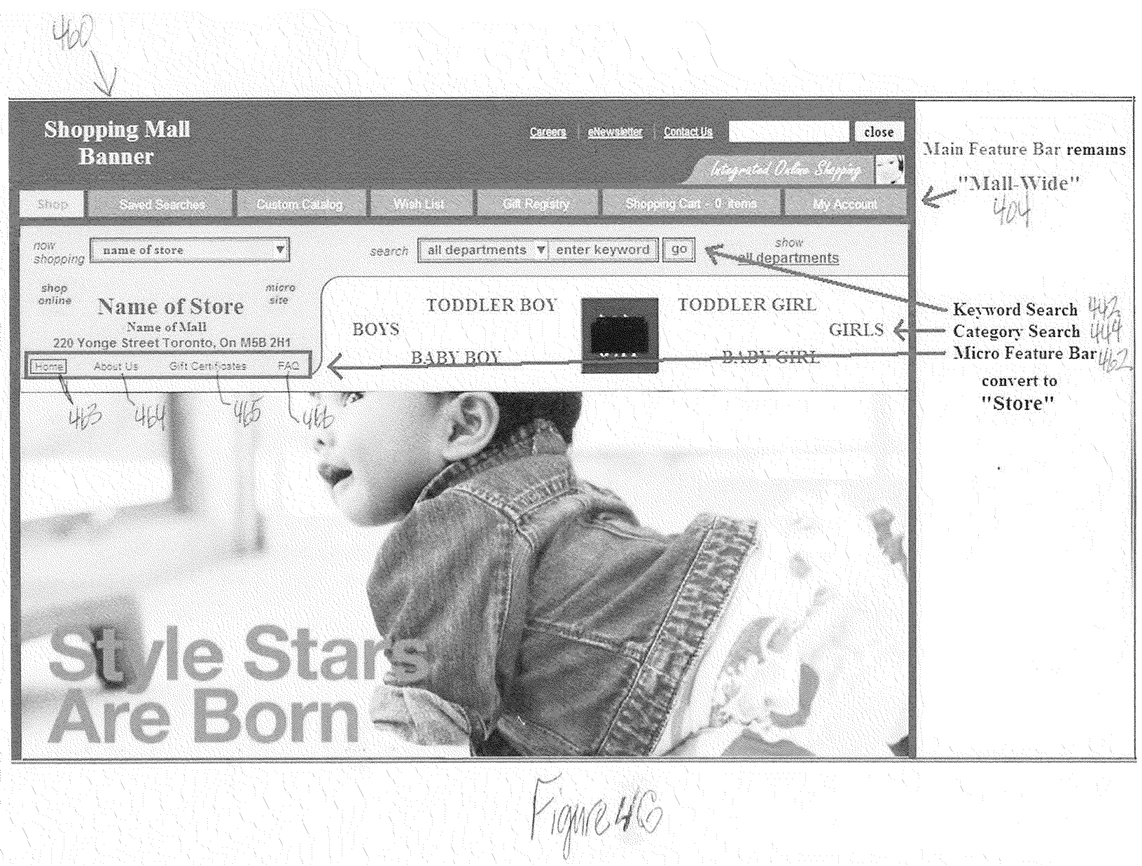

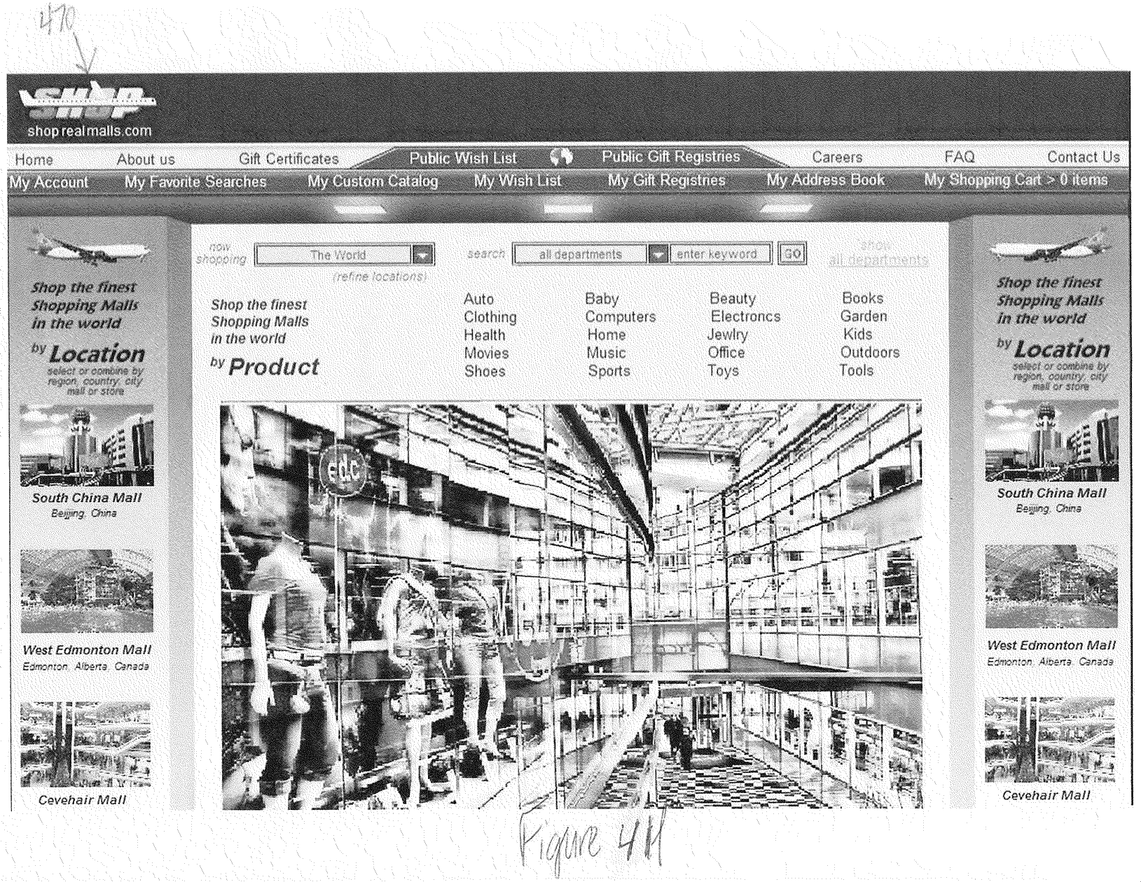

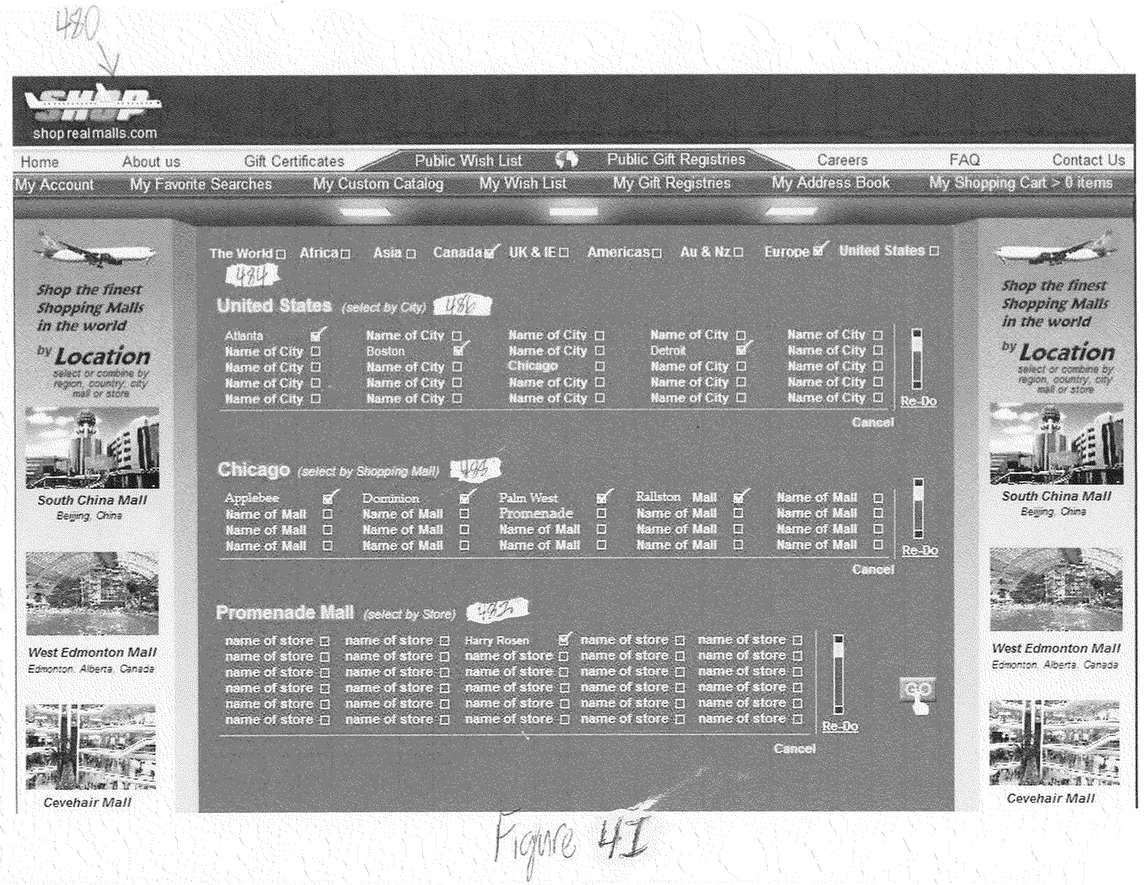

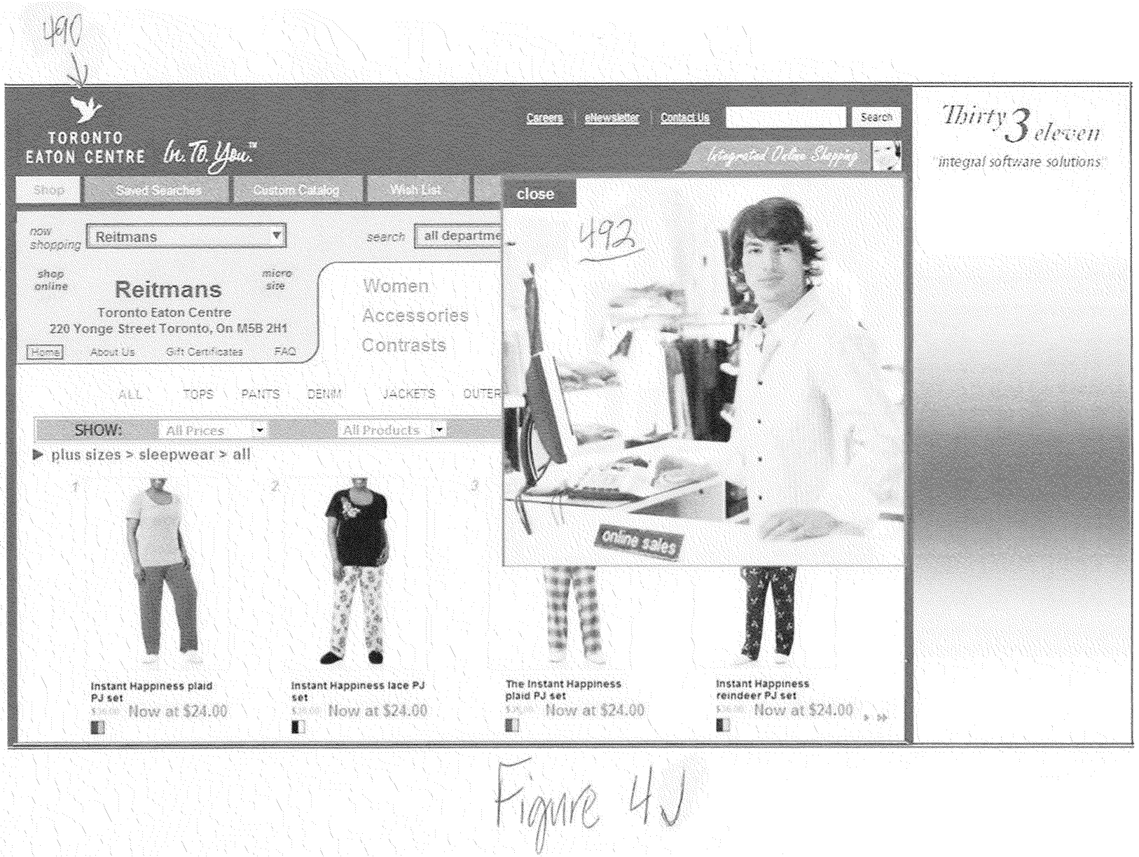

FIG. 4A illustrates a first shopping mall webpage 400 of the computerized system for e-commerce shopping, in accordance with one embodiment of the present invention. The first shopping mall webpage 400 includes a store directory 402 located on the main feature bar 404 that includes the name, a brief description, a phone number, operating hours and a mall floor plan highlighting the location of each store.

FIG. 4B illustrates a second shopping mall webpage 410 of the computerized system for e-commerce shopping, in accordance with one embodiment of the present invention. The second shopping mall webpage 410 includes a link to the web based e-commerce shopping application 412 entitled integrated online shopping.

FIG. 4C illustrates a third shopping mall webpage 420 of the computerized system for e-commerce shopping, in accordance with one embodiment of the present invention. The third shopping mall webpage 420 is the home page of the e-commerce shopping application 412.

FIG. 4D illustrates a fourth shopping mall webpage 430 of the computerized system for e-commerce shopping, in accordance with one embodiment of the present invention. The fourth shopping mall webpage 430 includes the main feature bar 404 that includes a saved searches link 431, a custom catalog link 432, a wish list link 433, a gift registry link 434, a shopping cart link 435 and an account link 436.

FIG. 4E illustrates a fifth shopping mall webpage 440 of the computerized system for e-commerce shopping, in accordance with one embodiment of the present invention. The fifth shopping mall webpage 440 includes a key word search link 442, a category search link 444 and a store pull down menu 446.

FIG. 4F illustrates a micro shopping site webpage 450 of the computerized system for e-commerce shopping, in accordance with one embodiment of the present invention. The micro shopping site webpage 450 is an example of a micro shopping site webpage 450 that is part of the computerized system for e-commerce shopping.

FIG. 4G illustrates a main feature bar webpage 460 of the computerized system for e-commerce shopping, in accordance with one embodiment of the present invention. The main feature bar webpage 460 includes the main feature bar 404 that is mall wide, the key word search link 442, the category search link 444 and the micro feature bar 462 of a store and micro shopping site webpage 450 associated with the shopping mall. The micro feature bar 462 includes a home link 463, an about us link 464, a gift certificates link 465 and a frequently asked questions link 466 to a given store in the shopping mall.

FIG. 4H illustrates a first multiple mall webpage 470 of the computerized system for e-commerce shopping, in accordance with one embodiment of the present invention. The multiple mall webpage 470 features a fully integrated one stop online shopping experience to any store, or combination of stores, in any mall, or combination of malls, within any city, country or region of the world.

FIG. 4I illustrates a second multiple mall webpage 480 with a universal shopping cart of the computerized system for e-commerce shopping, in accordance with one embodiment of the present invention. The second multiple mall webpage 480 allows a shopper to choose a mall 482 in a continent 484, a country 486 and a city 488 from anywhere in the world and shop from that chosen mall.

FIG. 4J illustrates a live online on camera sales and information desk webpage 490 of the computerized system for e-commerce shopping, in accordance with one embodiment of the present invention. The live online on camera sales and information desk webpage 490 includes a live camera portion 492 where a user can see and interact with a live sales and information desk.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A computerized e-commerce shopping system utilized in a shopping mall, comprising:
a server system with a processor system, a communications interface, a communications system, an input system and an output system having access to a communications network;
a memory system with an operating system, a communications module, a web browser module, a web server application and an e-commerce shopping application that obtains, processes and stores e-commerce shopping information;
a client system with a processor system, a communications system, an input system and an output system in communication with said server system to receive e-commerce shopping information from said server system;
a shopping mall website; and
a plurality of micro shopping sites distributed to every retailer in said shopping mall to integrate seamlessly into said shopping mall websites.

2. The system according to claim 1, wherein said communications network is a local area network, a wide area network, a wireless network, a telephone network, an intranet and the Internet.

3. The system according to claim 1, wherein said e-commerce shopping application is a handheld wireless device application that includes a mobile phone application or a handheld network enabled audio and music player application.

4. The system according to claim 1, wherein said micro shopping sites provide a combined product database.

5. The system according to claim 4, wherein said combined product database includes a master product database, a mall wide search engine, a universal shopping cart and a unified wish list and a gift registry from which to feature a fully integrated one stop online shopping experience.

6. The system according to claim 5, wherein said master product database, said mail wide search engine, said universal shopping car and said unified wish list and said gift registry features a fully integrated one stop online shopping experience to any store, or combination of stores, in any mall, or combination of malls, within any city, country or region of the world.

7. The system according to claim 6, wherein said website includes a marketing component which enables said mall to launch a website online shopping feature with an online midnight madness sale feature utilizing a toggle switch on said mall's admin panel, allowing said mall to alternate from a regular banner to a midnight madness banner.

8. The system according to claim 7, wherein a plurality of store admin panels allow stores to alternate automatically from regular pricing to midnight madness pricing.

9. The system according to claim 1, wherein said micro shopping sites sell products, process orders and ship products and remove said mall from any actual transactions and liabilities.

10. The system according to claim 1, wherein said micro shopping sites offer said retailer a live online on camera sales and information desk.

11. The system according to claim 1, wherein said micro shopping sites are password protected.

12. A computerized e-commerce shopping system utilized in a shopping mall, comprising:
a server system with a processor system, a communications interface, a communications system, an input system and an output system having access to a communications network;
a memory system with an operating system, a communications module, a web browser module, a web server application and an e-commerce shopping application that obtains, processes and stores e-commerce shopping information;
a client system with a processor system, a communications system, an input system and an output system in communication with said server system to receive e-commerce shopping information from said server system;
a shopping mall website; and
a plurality of password protected micro shopping sites with a combined product database distributed to every retailer in said shopping mall to integrate seamlessly into said shopping mall websites.

13. The system according to claim 12, wherein said communications network is a local area network, a wide area network, a wireless network, a telephone network, an intranet and the Internet.

14. The system according to claim 12, wherein said e-commerce shopping application is a handheld wireless device application that includes a mobile phone application or a handheld network enabled audio and music player application.

15. The system according to claim 14, wherein said combined product database includes a master product database, a mall wide search engine, a universal shopping cart and a unified wish list and a gift registry from which to feature a fully integrated one stop online shopping experience.

16. The system according to claim 15, wherein said master product database, said mall wide search engine, said universal shopping cart and said unified wish list and said gift registry features a fully integrated one stop online shopping experience to any store, or combination of stores, in any mall, or combination of malls, within any city, country or region of the world.

17. The system according to claim 16, wherein said website includes a marketing component which enables said mall to launch a website online shopping feature with an online midnight madness sale feature utilizing a toggle switch on said mall's admin panel, allowing said mall to alternate from a regular banner to a midnight madness banner.

18. The system according to claim 17, wherein a plurality of store admin panels allow stores to alternate automatically from regular pricing to midnight madness pricing.

19. The system according to claim 12, wherein said micro shopping sites sell products, process orders and ship products and remove said mall from any actual transactions and liabilities.

20. The system according to claim 12, wherein said micro shopping sites offer said retailer a live online on camera sales and information desk.
